(19) United States
(12) Patent Application Publication
(10) Pub. No.: US 2005/0201487 A1
(43) Pub. Date: Sep. 15, 2005

(54) Pre-distortion method, measurement arrangement, pre-distorter structure, transmitter, receiver and connecting device

(76) Inventors: Dirk Gaschler, Wermelskirchen (DE); Olaf Schulte, Ratingen (DE); Lauri Kuru, Espoo (FI); Uwe Kaufer, Essen (DE); Ole Harmjanz, Essen (DE)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/845,577

(22) Filed: May 14, 2004

(30) Foreign Application Priority Data
Mar. 12, 2004 (FI) 20040393

(51) Int. Cl. H04L 25/03

(52) U.S. Cl. 375/296

(57) ABSTRACT

A transmitter and other features of a communication system include means for determining power of a signal to be pre-distorted for quantizing the power in a predetermined way and for selecting a corresponding power interval. The transmitter and other features also include means for deriving parameters defining a linear curve segment of the selected power interval are disclosed. The transmitter and other features also include means for calculating a gain factor by using the parameters defining the linear curve segment of the selected power interval and means for obtaining a pre-distorted signal.

### FIELD

The invention relates to a pre-distortion method, pre-distorter measurement arrangement, pre-distorter structure, receiver, transmitter and connecting device.

### BACKGROUND

Due to non-linear effects of the analogue components of the transmission chain, the transmitted signal is disturbed in amplitude and phase. The distortions depend on the signal magnitude. The higher the signal magnitude, the more significant the distortions are.

The main cause for the non-linearity is the power amplifier of the transmitter. Besides amplifying the wanted signal the power amplifier generates higher order harmonics of the original signal spectrum. The spread of the signal spectrum causes two major effects: the requirements for the radio frequency spectrum are not fulfilled and detection of the distorted signal in the receiver suffers from errors.

The spread of the signal spectrum can be avoided by reducing signal power. This, however, leads to inefficient use of the amplification stage.

### BRIEF DESCRIPTION OF THE INVENTION

An object of the invention is to provide an improved pre-distortion method, pre-distorter measurement arrangement, pre-distorter structure, receiver, transmitter and connecting device.

According to an aspect of the invention, there is provided a predistortion method in a communication system, the communication system comprising at least one transmitter and at least one receiver, the method comprising: defining in-phase and quadrature differences of a received signal sample and a symbol decision for each constellation point, and conveying the defined in-phase and quadrature differences to a transmitter, forming power intervals on the basis of the modulation method used, determining the power of a signal to be pre-distorted, quantizing the power in a predetermined way and selecting a corresponding power interval, averaging the in-phase and quadrature differences, rotating the averaged in-phase and quadrature differences towards the in-phase axis of the in-phase and quadrature plane and performing amplification and a running mean calculation for deriving parameters defining a linear curve segment of the selected power interval, calculating a gain factor by using the parameters defining the linear curve segment of the selected power interval for obtaining a pre-distorted signal.

According to another aspect of the invention, there is provided a predistortion method in a communication system, the communication system comprising at least one transmitter and at least one receiver, the method comprising: defining in-phase and quadrature differences of a received signal sample and a symbol decision for each constellation point, and conveying the defined in-phase and quadrature differences to a transmitter, forming power intervals on the basis of the modulation method used, determining the power of a signal to be pre-distorted, quantizing the power in a predetermined way and selecting a corresponding power interval, deriving parameters defining a linear curve segment of the selected power interval, calculating a gain factor by using the parameters defining the linear curve segment of the selected power interval for obtaining a pre-distorted signal.

According to another aspect of the invention, there is provided a receiver of a communication system, comprising: means for defining in-phase and quadrature differences of a received signal sample and a symbol decision for each constellation point, means for conveying the defined in-phase and quadrature differences to a transmitter.

According to another aspect of the invention, there is provided a transmitter of a communication system, comprising: means for determining power of a signal to be pre-distorted, quantizing the power in a predetermined way and selecting a corresponding power interval, means for averaging in-phase and quadrature differences, rotating the averaged in-phase and quadrature differences towards the in-phase axis of the in-phase and quadrature plane and performing amplification and a running mean calculation for deriving parameters defining a linear curve segment of the selected power interval, means for calculating a gain factor by using the parameters defining the linear curve segment of the selected power interval, means for obtaining a pre-distorted signal.

According to another aspect of the invention, there is provided a transmitter of a communication system, comprising: means for determining power of a signal to be pre-distorted, quantizing the power in a predetermined way and selecting a corresponding power interval, means for deriving parameters defining a linear curve segment of the selected power interval, means for calculating a gain factor by using the parameters defining the linear curve segment of the selected power interval, means for obtaining a pre-distorted signal.

According to another aspect of the invention, there is provided a receiver of a communication system, comprising: defining means defining in-phase and quadrature differences of a received signal sample and a symbol decision for each constellation point, conveying means conveying the defined in-phase and quadrature differences to a transmitter.

According to another aspect of the invention, there is provided a transmitter of a communication system, comprising: power processing means determining power of a signal to be pre-distorted, quantizing the power in a predetermined way and selecting a corresponding power interval, averaging means averaging in-phase and quadrature differences, rotating the averaged in-phase and quadrature differences towards the in-phase axis of the in-phase and quadrature plane and performing amplification and a running mean calculation for deriving parameters defining a linear curve segment of the selected power interval, calculating means calculating a gain factor by using the parameters defining the linear curve segment of the selected power interval, obtaining means obtaining a pre-distorted signal.

According to another aspect of the invention, there is provided a transmitter of a communication system, comprising: power processing means determining power of a signal to be pre-distorted, quantizing the power in a predetermined way and selecting a corresponding power interval, determining means determining parameters defining a linear curve segment of the selected power interval, calculating means calculating a gain factor by using the parameters defining the linear curve segment of the selected power interval, obtaining means obtaining a pre-distorted signal.

According to another aspect of the invention, there is provided a predistorter measurement arrangement of a receiver, comprising: means for defining in-phase and quadrature differences of a received signal sample and a symbol decision for each constellation point, means for conveying the defined in-phase and quadrature differences to a transmitter.

According to another aspect of the invention, there is provided a predistorter structure of a transmitter, comprising: power processing means determining power of a signal to be pre-distorted, quantizing the power in a predetermined way and selecting a corresponding power interval, averaging means averaging in-phase and quadrature differences, rotating the averaged in-phase and quadrature differences towards the in-phase axis of the in-phase and quadrature plane and performing amplification and a running mean calculation for deriving parameters defining a linear curve segment of the selected power interval, calculating means calculating a gain factor by using the parameters defining the linear curve segment of the selected power interval, obtaining means obtaining a pre-distorted signal.

According to another aspect of the invention, there is provided a predistorter structure of a transmitter, comprising: power processing means determining power of a signal to be pre-distorted, quantizing the power in a predetermined way and selecting a corresponding power interval, determining means determining parameters defining a linear curve segment of the selected power interval, calculating means calculating a gain factor by using the parameters defining the linear curve segment of the selected power interval, obtaining means obtaining a pre-distorted signal.

According to another aspect of the invention, there is provided a connecting device of a communication system, comprising: power processing means determining power of a signal to be pre-distorted, quantizing the power in a predetermined way and selecting a corresponding power interval, averaging means averaging in-phase and quadrature differences, rotating the averaged in-phase and quadrature differences towards the in-phase axis of the in-phase and quadrature plane and performing amplification and a running mean calculation for deriving parameters defining a linear curve segment of the selected power interval, calculating means calculating a gain factor by using the parameters defining the linear curve segment of the selected power interval, obtaining means obtaining a pre-distorted signal.

According to another aspect of the invention, there is provided a connecting device of a communication system, comprising: power processing means determining power of a signal to be pre-distorted, quantizing the power in a predetermined way and selecting a corresponding power interval, determining means determining parameters defining a linear curve segment of the selected power interval, calculating means calculating a gain factor by using the parameters defining the linear curve segment of the selected power interval, obtaining means obtaining a pre-distorted signal.

Embodiments of the invention are described in the dependent claims.

The method and system of the invention provide several advantages. In a preferred embodiment of the invention, there is provided a pre-distorter of a power amplifier that diminishes the signal spectrum spread.

### LIST OF DRAWINGS

In the following, the invention will be described in greater detail with reference to the preferred embodiments and the accompanying drawings, in which

FIG. 1 is a flow chart,

FIG. 2A illustrates amplitude intervals,

FIG. 2B shows how the slope of one curve segment, i.e. abs(A(P)), is the same as the amplitude gain,

FIG. 3 illustrates a receiver,

FIG. 4 shows a transmitter,

FIG. 5 shows a microprocessor of a transmitter and

FIG. 6 illustrates one curve segment for clarifying the definition of real parts of pre-distorter gain A(P) with coefficient m and b.

### DESCRIPTION OF EMBODIMENTS

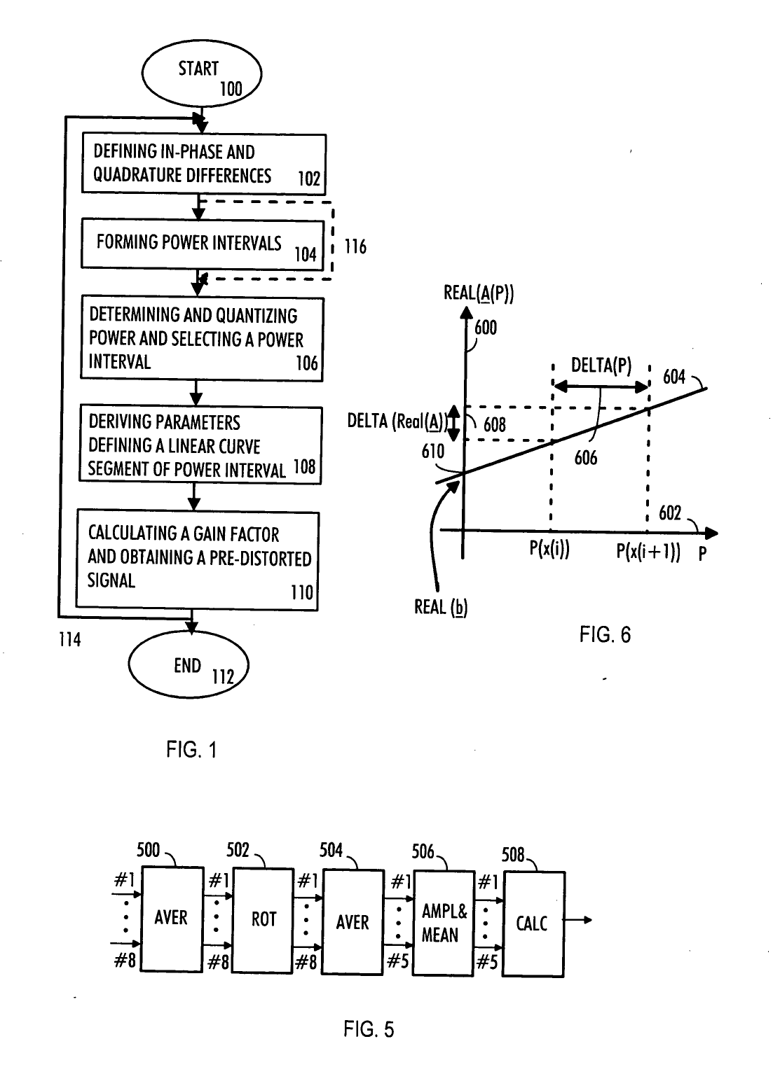

FIG. 1 is a flow chart showing an embodiment of a pre-distortion method in a telecommunication system where the telecommunication system includes at least one transmitter and at least one receiver providing receiver side distortion measurements. The system usually also comprises means for conveying distortion measurement results from the receiver to the transmitter, since the receiver and the transmitter are typically not located in proximity to each other. The transmitter of the system uses, for instance, an adaptive piece-wise linear method. Typically, the measurement and the pre-distortion are carried out for each symbol. The main goal of the pre-distortion is to be able to use higher transmit powers in the non-linear range of the power amplifier without violating the spectral mask.

Since, typically, the measurements are carried out in the receiver and the actual pre-distortion in the transmitter, there is data to be exchanged between the communication elements. The data exchange typically takes place on a so-called back channel that is used for exchanging link management data.

The implementation of the method may vary: I (in-phase) and Q (quadrature) difference measurements are preferably carried out in the receiver and the actual signal pre-distortion is carried out in the transmitter, but other method steps can be carried out at either end. Typically, the actual pre-distortion steps are performed on the transmitting side, because the transmitter has better knowledge of which parameters would be most suitable during the adaptation process.

The embodiment starts from block 100. In block 102, in-phase (I) and quadrature (Q) differences between a received signal sample and a symbol decision for each constellation point are typically defined in a receiver and conveyed to a transmitter.

The definition is carried out in each sampling interval. The term I and Q difference typically means the same as the term I and Q error (I meaning in-phase and Q quadrature).

The I and Q values have to be measured separately for each possible magnitude (magnitude means in a constellation diagram a circle of constellation points located approximately at the same distance from the origin). If a multi-level-QAM modulation such as 32QAM (quadrature amplitude modulation), is used, it may be possible to minimize the number of measurements, for example in the case of 32QAM, to 8 by transforming 32 constellation points into the first quadrant of the constellation diagram circle. An average is typically calculated for each measurement by accumulating a programmable number of measurements.

The following steps of embodiment are typically carried out in a predistorter of a transmitter. The pre-distorter of the transmitter may be located in a base station (called also a node B) or in an equivalent network element of a communication system. The system may also be a point-to-multipoint (or a point-to-point, a multipoint-to-multipoint, a mesh-radio network etc.) system, in which case the pre-distorter may be located in an element comprising required facilities. The network element is called a connecting device in this application.

In the pre-distortion carried out in the transmitter, it is important to take into account the data units of difference measurements; the receiver measures and returns the measurement data using certain data units, and the used data format has to be known in the transmitter for interpretation of data.

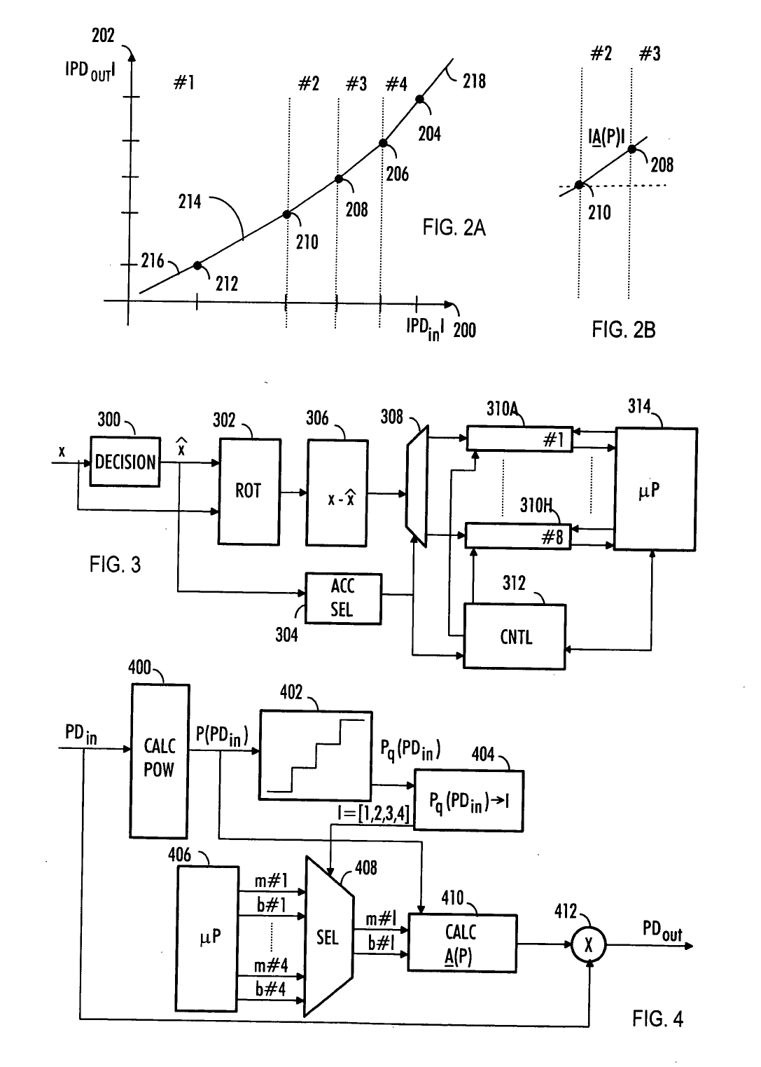

In block 104, power intervals are formed on the basis of the modulation method used. Amplitude intervals (power values being obtained from amplitude values by squaring) are explained in further detail with the aid of the example depicted in FIG. 2A. Power intervals are typically defined before starting the pre-distortion process for each modulation method used in the communication system. It is possible to update power intervals during the pre-distortion process but in practice this is typically not required. In FIG. 1, arrow 116 depicts the possibility to form the power intervals only once.

In FIG. 2A, amplitude intervals are depicted. On the x-axis 200, there are input amplitude values and on the Y-axis 202, there are output amplitude values. The example of FIG. 2A illustrates 32QAM system where there are five different magnitudes representing amplitudes of constellation points marked with dots 204, 206, 208, 210, 212. As can be seen in FIG. 2A, the amplitude interval curve 214 can be thought to be composed of several straight lines (curve segments). Curve segments are marked in FIG. 2A by #1, #2, #3, #4. Thus the curve 214 can be thought to be piecewise linear.

In digital hardware it is easier to calculate the power rather than the amplitude of a complex value, and therefore it is easier to decide to which input power interval rather than to which amplitude interval the current input value belongs. The corresponding input power versus output power relationship is very similar to the input amplitude versus output amplitude relation shown in FIG. 2A: only the slope is squared, (abs(A))²=real(A(i))²+imag(A(i))².

In block 106, the power of the signal to be pre-distorted is determined, the power is quantized in a predetermined way and a corresponding power interval, e.g. the linear curve segment to which the current input value belongs, is selected. As said earlier, in digital hardware it is easier to calculate the power rather than the amplitude of a complex value, and therefore it is easier to decide to which input power interval rather than to which amplitude interval the current input value belongs.

The pre-distorter locates in a transmitter preferably after digital pulse shaping and low-pass filters in order that a signal spectrum can be formed to fulfil the requirements of the system specification in question. However, digital pulse shaping and low-pass filters generate additional values due to interpolation between constellation points. The complex amplitude of those values can be below or above the complex amplitude of the constellation points according to the modulation method used. The complex amplitude can also be between two constellation points. The receiver gives information on in-phase (I) and quadrature (Q) component differences only for the constellation points. As the amount of I and Q (corresponds to amplitude and phase) compensation of pre-distortion depends on the complex input amplitude, an output value for values other than actual constellation points is also generated.

For values (reference points) other than constellation points, interpolation or extrapolation is used for approximation: for intermediate values (intermediate reference points) interpolation is used and for values (reference points) having complex amplitudes above the outermost constellation circle or below the innermost circle, extrapolation is used.

A linear interpolation (or extrapolation) is selected in this embodiment for its simplicity, but other methods can also be used. There are several possibilities, for instance increasing the number of linear curve segments that smoothens the input and output relationship curve and/or using a higher order interpolation method, such as cubical interpolation. Higher order interpolation methods can also be used as an intermediate step in such a way that first desired pre-distortion curves are computed using higher order interpolation/extrapolation methods and then the desired curves are approximated by using a multitude of piecewise linear segments.

In FIG. 2A, there is illustrated as an example a 32QAM system, where there are five different magnitudes representing amplitudes of constellation points marked with dots 204, 206, 208, 210, 212.

There are three different cases: Firstly, amplitudes between two circles of the constellation diagram are processed. In this embodiment, linear interpolation between the constellation points in question is used, for instance between constellation points 208 and 210. Secondly, amplitudes below the innermost circle are processed. In the embodiment, an extrapolation of the linear interpolation line between the two innermost constellation circles 210, 212 is extended towards the y-axis marked with line 216. An alternative implementation would be to interpolate between the innermost circle and the origin. Thirdly, amplitudes above the outermost circle are processed. For extrapolation, the linear interpolation line between the two outermost circles 204, 206 is extended, which is marked with line 218.

The power is quantized to the input power intervals defined by the modulation method used. In the example of FIG. 2A, i.e. 32QAM, there are 4 power intervals, and hence the power is quantized according to these levels. Then the corresponding power interval, e.g. the linear curve segment to which the current input value belongs, is selected.

In the following, complex values are marked using underlining.

The pre-distortion is carried out in the Cartesian coordinate system in the following form:
PDₒᵤₜ=PDᵢₙ·A(P), (1)
wherein
PDᵢₙ is a complex input signal of the pre-distorter,
PDₒᵤₜ is a complex output signal of the pre-distorter and
A(P) is a complex linear interpolation depending on input power P.

In the equation (1) power is used, since in this way less computational effort is required than if the input amplitude SQRT( ) were used.

In block 108, parameters defining the linear curve segment of a power interval are determined. The angular coefficient (slope) and the y-axis intersection of each of the complex valued line segments can be derived. Since piece-wise linear approximation is used, each segment can be expressed as follows:
A(P)=m·P+b, (2)
wherein
A(P) is a complex linear interpolation depending on input power P,
P is input power,
m is a slope and
b is y-axis intersection.

Parameters m and b are called here parameters defining a linear (complex) curve segment of a power interval.

Next an example of calculation of parameters defining the power intervals is explained for 32QAM. The accumulated I and Q differences conveyed from the receiver to the transmitter are averaged by dividing them by the number of samples. The averaging is carried out for I and Q components.

If several constellation points are located on the same circle of the constellation diagram, it is possible to calculate a mean value for the amplitude and phase difference of those constellation points. In 32QAM systems, it is possible to reduce the number of constellation points to be processed to five by using the possibility of calculating mean values. For that purpose, the averaged I and Q differences are rotated towards the in-phase axis of the I and Q plane by the same angle that would be needed to rotate the corresponding reference point towards the in-phase axis. The resulting complex values are called errₐᵥ_{_{—}}_{circ} (i) in the following. The rotation can be done by means of complex multiplication of each averaged difference with a complex rotator.

In order to control the stability of the closed loop, amplification and a running mean calculation is carried out. The purpose of the amplification is to use only a fraction of the measured errors for pre-distortion.

In principle, the pre-distorter is designed to minimize the average phase and amplitude errors measured in the receiver's decision device. This target is beneficial for optimising bit error performance, but not for optimising the transmitter's output spectrum. Completely minimizing the phase and amplitude errors (also called difference in this application) at the receiver leads to spectral degradation of the transmitted signal at high output power levels. While in-band spectral distortions are reduced, out-of-band spectral components can grow so much that the spectral mask will be violated.

Therefore a trade-off is usually carried out between the bit error performance in the receiver and the signal spectrum shape requirements of a transmitted signal. The programmable amplification factor C is designed for the trade-off. The larger the factor C is, the larger is the fraction of the measured distortion, which is used for calculating the pre-distortion parameters.

The running mean has a smoothing effect that enables reaching a steady state from large initial deviations or to cope with occasional unreliable measurements. The smoothing and the speed of convergence are influenced by the ratio of the factor C and an independently programmable factor N. While C is used to control the amount of distortion correction, N is used to control the smoothing and the speed of convergence.

The amplification and running mean calculation are carried out for each of the five difference values by using the following equation:

$${\underline{rm}}_{n} ( i ) = {\underline{rm}}_{n - 1} ( i ) + \frac{C \cdot {\underline{err}}_{{av\_circ}_{n}} ( i ) - {\underline{rm}}_{n - 1} ( i )}{N} , \qquad ( 3 )$$

wherein
errₐᵥ_{_{—}}_{circ} (i) is one of the 5 remaining complex valued differences,
C is the amplification factor,
rm(i) is a complex running mean value,
i is a circle index,
n is the time index,
N is the time constant of the iterative running mean calculation, or equivalently

$${\underline{rm}}_{n} ( i ) = \frac{C}{N} \cdot {\underline{err}}_{{av\_circ}_{n}} ( i ) + ( 1 - \frac{1}{N} ) \cdot {\underline{rm}}_{n - 1} ( i ) \qquad ( 4 )$$

wherein
errₐᵥ_{_{—}}_{circ} (i) is one of the 5 remaining complex valued differences,
C is the amplification factor,
rm(i) is a complex running mean value,
i is a circle index,
n is the time index,
N is the time constant of the iterative running mean calculation.

Other calculation methods are also possible such as calculating the running mean with the errₐᵥ_{_{—}}_{circ} (i) and then amplifying the result by C.

C/N defines the smoothing and the time that is needed to reach a steady running mean. For fixed C and small N values, the convergence and tracking speed are fast, and for large N values, the convergence and tracking speed are low.

For preventing spectral mask violations without pre-distortion, the initial state of the running mean at start-up at low output powers outside the non-linear range is typically set to zero, in other words rm0(i)=0.0. If the desired transmit power is in the non-linear range, the transmit power can be gradually (e.g. 0.5 dB) increased after waiting for sufficient (e.g. 30) convergence rounds of the pre-distortion parameters until the final power is reached. To make quick power changes possible, the intermediate pre-distortion parameters and the corresponding running means are typically stored in a look-up-table (LUT) which allows fast recall of pre-distortion parameters and corresponding running means for transmit power values in the non-linear range. This LUT is also kept in a non-volatile memory to allow for its reuse after power failures.

The amplitude difference and phase difference, which are the basis for pre-distortion parameters, are then calculated.

Since the phase difference may be assumed to be relatively small compared with the amplitude difference, the averaged received amplitude of a certain constellation diagram circle can be approximated as:
Amp(i)=abs(x(i))+Re(rmₙ(i), (5)
wherein
x(i) is a constellation point,
i means a circle number,
Re means a real part,
abs means an absolute value and
rmₙ means a running mean,
   and an averaged received phase of a certain constellation diagram circle can be calculated as:
   Phase(i)=Im(rmₙ(i))/(abs(x(i))+Re(rmₙ(i))), (6)
   wherein
Im means an imaginary part,
abs means an absolute value,
x(i) is a constellation point,
Re means a real part,
i means a circle number and
rmₙ means a running mean.

The pre-distorter is designed to compensate amplitude and phase distortions. The amplitude compensation can be done by dividing reference amplitudes by the averaged received amplitudes calculated according to equation (5). If the averaged received amplitude Amp(i) is less than abs(x(i)), the inverse gain difference is greater than one. In other words the pre-distorter increases the amplitude.

The inverse phase difference is the averaged received phase calculated by using equation (6) times (−1).

Thus we get
Inv_Amp(i)=abs(x(i))/Amp(i), (7)
wherein
abs means an absolute value,
x(i) is the complex reference point on the circle i and
Amp(i) is received from equation (5),
   and
   Inv_Phase(i)=−1·Phase(i), (8)
   wherein
Phase(i) is obtained from equation (6).

The equations above are derived for systems working in polar coordinates. As pre-distorters usually operate in the Cartesian coordinate system, equations (7) and (8) have to be transferred into Cartesian coordinates. Thus we get for a real part of the complex correction coefficient
real(A(i))=Inv_Amp(i)*cos(Inv_Phase(i)) (9)
and for an imaginary part
imag(A(i))=Inv_Amp(i)·sin(Inv_Phase(i)). (10)

Attention should be paid that equation (9) and (10) are valid only for constellation points, not for intermediate points. Correction coefficients for intermediate points can be obtained by means of interpolation as shown earlier. The sine and cosine functions can be further simplified by using truncated Taylor series approximation. Taylor series are well known by a person skilled in the art.

If the pre-distortion parameters are stored to hardware (HW), the resolution is limited. The parameters are rounded to the allowed bit size, optionally taking care that the linear interpolations do not lead to jumps of the predistortion gain parameters at the borders of segments.

In FIGS. 2A-B, the y-axis shows output amplitude values. The |A(i)|, i.e. the absolute value of the complex gain, is equivalent to the gain factor between |PDᵢₙ| and |PDₒᵤₜ|.

The power of the reference circles can be expressed as follows:
P(i)=abs(x(i))², (11)
wherein
abs means an absolute value and
x(i) is the complex reference point on the circle i.

An angular coefficient and the y-axis intersection (output amplitude or power) for each complex line segments can be derived as follows when the graph is thought to be piecewise linear.

One curve segment 604 is shown in FIG. 6. It is shown here for clarifying a definition of real parts of pre-distorter coefficients m and b. On the vertical axis 600 there is a real part of the gain factor A(P) and on the horizontal axis 602 there is input power P. In the pre-distortion method, complex m and b factors representing the slope (m) and y-axis crossing 610 (_) of the complex gain factor A(i) are derived according to equations (9) and (10).

The output amplitude (see FIGS. 2A-B) is related to the input amplitude via the amplitude gain factor which is equal to the absolute value of the complex gain factor A(P). The output phase is related to the input phase via the phase gain factor which is equal to the phase of the complex gain factor A(P).

There are depicted input powers P of two consecutive complex reference points x(i) and x(i+1). The amplitude difference DELTA(Real(A)) 608 is obtained from the vertical axis and the input power difference DELTA(P) 606 from the horizontal axis. The real part of the slope (real(m)) is DELTA(Real(A))/DELTA(P).

Dotted lines are used in FIG. 2B as construction lines for illustrating DELTA(Real(A)) and DELTA(P). A similar Figure can be depicted for the imaginary parts of m, b and A.

Each segment was expressed above in equation (2) as follows:
A(P)=m·P+b, (2)
wherein
A(P) is a complex linear interpolation depending on input power P or a gain factor,
P is input power (or amplitude),
m is an angular coefficient (slope) and
b is y-axis intersection.

Next, calculation of m and b (parameters defining the linear curve segment of a power interval) is explained in further detail.

Because a 32QAM system is used here as an example, the following equations are shown for 4 line segments from five complex gain values corresponding to five reference circles. A new index I meaning each line segment (I goes 1 to 4) is introduced. First a real part and an imaginary part of m is calculated:

$$real \{ \underline{m} ( l ) \} = \frac{real ( \underline{A} ( l + 1 ) ) - real ( \underline{A} ( l ) )}{{abs ( \underline{x} ( l + 1 ) )}^{2} - {abs ( \underline{x} ( l ) )}^{2}} , \qquad ( 12 )$$

wherein
real means a real value,
A is an input amplitude,
abs means an absolute value and
x means the complex reference point on the circle in question,
(including possible amplification of circuits between modulator and predistorter like pulse sharpening),

$$and imag \{ \underline{m} ( l ) \} = \frac{imag ( \underline{A} ( l + 1 ) ) - imag ( \underline{A} ( l ) )}{{abs ( \underline{x} ( l + 1 ) )}^{2} - {abs ( \underline{x} ( l ) )}^{2}} , \qquad ( 13 )$$

wherein
imag means an imaginary value,
A is an input amplitude,
Abs means an absolute value and
x means the complex reference point on the circle in question,
(including possible amplification of circuits between modulator and predistorter like pulse sharpening).

Next a real part and an imaginary part of b is calculated:
real{b(l)}=real(A(l))−real{m(l)}·abs(x(l))², (14)
wherein
real means a real value,
A is an input amplitude,
Abs means an absolute value,
x means the complex reference point on the circle in question x means the complex reference point on the circle in question,
(including possible amplification of circuits between modulator and predistorter like pulse sharpening),
real {m(l)} is the real part of the angular coefficient, which is calculated by using equation (12).

An imaginary part of b is calculated:
imag{b(l)}=imag(A(l))−imag{m(l)}·abs(x(l))², (15)
wherein
imag means an imaginary value,
A is an input amplitude,
abs means an absolute value,
x means the complex reference point on the circle in question x means the complex reference point on the circle in question,
(including possible amplification of circuits between modulator and predistorter like pulse sharpening),
imag {m(l)} is the imaginary part of the angular coefficient, which is calculated by using equation (13).

In block 110, a gain factor A(P) which usually is complex valued is calculated by using the parameters defining the complex linear curve segment of the power interval in question, i.e. m and b (see Equation 2). The signal is predistorted by multiplying it with the gain factor A(P).

The embodiment ends in block 112. Arrow 114 depicts one possibility for repeating the embodiment. Several iterations are usually required to make the method converge. Temperature changes and aging may cause that updating of pre-distortion parameters to be indispensable.

The method may be implemented in several kinds of communication systems. One example is point-to-point (or point-to-multipoint) systems. To point-to-point (or point-to-multipoint) systems, it is possible to apply a hot standby (HSB) equipment protection method. In the hot standby method, there are one or more auxiliary radio units ready to take over the functions of the active radio unit if a failure occurs. There are several failure types: a radio unit becomes unavailable, the reception of a radio signal does not succeed, or there is degradation in the signal quality causing too many bit errors in the detection. The name “hot standby” comes from the fact that the protecting radio unit is in the “hot standby” mode: the transceivers of both radio units are switched on, but the transmitter of the protecting radio unit is muted.

The procedure of defining the pre-distortion parameters can be described as two nested loops: the outer loop increases the transmission power in small steps until the target transmit power is reached. The inner loop performs pre-distortion updates for fixed transmission power, starting with the minimum power not causing spectral mask violation. The default parameters for the predistorter at the first start-up could be, for instance, m=0 and b=1. Then the process continues using measurement results for the following iteration steps.

The transmission power is usually prevented from increasing above a predetermined limit in order to prevent spectral mask violations. If the typical implementation dependent limits set for the pre-distortion parameters are reached, the microprocessor may restrict the increase of the transmission power. The restriction also prevents internal overflows in addition to preventing spectral mask violations.

Radio conditions may also change rather quickly, in which case the system has to switch quickly from one transmission power to another. To avoid several iteration steps, each of which would have a small power change, the previously calculated pre-distortion parameters and running means can be stored in a look-up-table (LUT). The LUT may also be stored in a persistent, non-volatile memory to allow the use of parameters after power failures or at new start-ups. Also regular updates of the pre-distortion parameters can be carried out to adjust the system to aging or temperature change effects. A sequence number may be used to avoid using the same measurement information twice.

In the following, an example of an arrangement used for pre-distortion measurements in the receiver is explained with the aid of FIG. 3. The arrangement is typically located in the proximity of the decision device, as can be seen in FIG. 3. The receiver may be located, for example, in a user terminal of a communication system. The receiver may also be located in a base station (also called node B) or in an equivalent network element of a communication system. The system may also be a point-to-multipoint (or a point-to-point, a multipoint-to-multipoint, a mesh-radio network etc.) system, in which case the pre-distorter may be located in an element comprising required facilities. The network element is called a connecting device in this application.

It is obvious to a person skilled in the art that the receiver may also include elements other than those illustrated in FIG. 3.

In the embodiment, a received signal sample arrives in a decision device 300. The received signal sample and a detected symbol are taken to a rotation block 302. In the rotation block, the sample and the detected symbol are rotated into the 1^{st} quadrant of the constellation diagram for minimizing the number of required measurements. Constellation diagrams are known to a skilled person.

The difference (error) between the received signal sample and the detected symbol is calculated for in-phase and quadrature components in block 306. The in-phase component difference is the difference between the in-phase component of the received sample and the in-phase component of the detected symbol. Correspondingly, the quadrature component difference is the difference between the quadrature component of the received sample and the quadrature component of the detected symbol.

Usually, the amplitude and phase differences are calculated in the Cartesian domain by calculating I and Q differences.

Blocks 304 and 308 deliver the calculated differences to the corresponding memory unit 310A-H (only the first one and the last one are depicted in FIG. 3) according to the constellation point. If 32QAM is used and the signal samples as well as the detected symbols are rotated to the 1^{st} quadrant, there are 8 different constellation points and therefore 8*2=16 (separate storages for real and imaginary values) memory units or parts of a memory unit.

A microprocessor 314 may average the differences for improving the accuracy of the amplitude and phase information conveyed to a transmitter. It is also possible that averaging is done in the transmitter and in that case the microprocessor's main task is to control on the information feed to the transmitter. Block 312 is a control block controlling the memory usage and calculation process in the microprocessor 314. The described arrangement is typically located in an ASIC (application-specific integrated circuit) component. Another possible implementation is an FPGA (field-programmable gate arrays), a DSP (digital signal processing) or even a general purpose processor. The required processing speed mainly determines the implementation.

A generalised example of a pre-distorter of a transmitter is described next in further detail with the aid of FIGS. 4 and 5. It is obvious to a person skilled in the art that the pre-distorter may also include elements other than those illustrated in FIGS. 4 and 5. The pre-distorter may be located in a base station (called also a node B), in a radio network controller or in an equivalent network element of a communication system. The system may also be a point-to-multipoint (or a point-to-point, a multipoint-to-multipoint, a mesh-radio network etc.) system, in which case the pre-distorter may be located in an element comprising required facilities. The network element is called a connecting device in this application.

The pre-distorter is usually located after digital pulse shaping and lowpass filters if the signal spectrum is to be improved. These filters, however, generate signal values between constellation points. Therefore interpolation and/or extrapolation are used, as explained above.

If harmonics of the base-band signal are to be compensated, oversampling is typically needed. If a sample rate equal to or higher than four times the symbol rate is used, over-sampling requirements are typically fulfilled. Spectral components generated by the pre-distorter are aliased back to the frequency region up to the Nyquist frequency. Therefore, the higher the sample rate, the better the pre-distortion result, because spectral components having high frequencies attenuate more rapidly than components having low frequencies. Another advantage of using very high over-sampling is that, depending on the absolute value of the over-sampling factor, also compensation up to higher harmonics than the 3^{rd} harmonics of the base-band spectrum is possible.

The input signal of the pre-distorter is conveyed to block 400, where the signal power is determined. The determined power is then conveyed to block 402, where the power values are quantized on the basis of power intervals used in the current embodiment. In the case of 32QAM, there are 4 different power intervals. An example of power intervals is depicted in FIG. 2. In block 404, it is decided to which power interval (linear curve segment) the current input value belongs.,

Microprocessor 406 calculates parameters defining complex linear curve segments of the power intervals, i.e. m and b. The calculation is described with the aid of FIGS. 5 and 2B. In FIG. 2B, it is depicted how the slope of one curve segment, i.e. IAI, is the same as the amplitude gain. The dotted line is used as a construction line.

The receiver transmits the I and Q information to the transmitter via the back-channel. In the transmitter, the information is conveyed to the microprocessor 406. In this ex-ample, there are eight different input values.

In block 500, the I and Q differences are averaged (if this has not been done in the receiver). Then the averaged differences are rotated towards the in-phase axis in block 502. The rotation angle is typically the angle that would be needed to rotate the corresponding reference point towards the I axis. The rotation can be done by means of complex multiplication of each averaged difference with a complex rotator that is unique for each corresponding reference point.

In block 504, rotated differences that belong to the same constellation circle are averaged. When 32QAM is used, it is possible to create a model depicted in FIG. 2A and there are five different output values from block 504. In block 506, amplification and a running mean calculation are carried out for ascertaining a stable pre-distorter in which overcompensating is not performed.

In block 508, parameters defining the complex linear curve segments of the power intervals, i.e. m and b, are calculated. The calculation is explained in greater detail above.

Parameters m and b corresponding to the current line segment of the power diagram (see FIG. 6) are selected in block 408. For values other than constellation points, interpolation or extrapolation is used for approximation in block 410: for intermediate values interpolation is used and for values having amplitudes above the outermost constellation circle or below the innermost circle by extrapolation. A linear interpolation (or extrapolation) is selected in this embodiment for its simplicity, but other methods can also be used.

In block 410, a gain factor A(P) is determined.

The complex input signal of the pre-distorter is multiplied in block 412 by the complex gain factor A(P) for deriving a complex pre-distorted signal.

The described arrangements are typically located in one or more ASIC (application-specific integrated circuit) components. Another possible implementation is an FPGA (field-programmable gate arrays), a DSP (digital signal processing) or even general a purpose processor. The required processing speed mainly determines the implementation.

The implementations may vary: I (in-phase) and Q (quadrature) difference measurements are preferably done in the receiver, and the actual signal pre-distortion is done in the transmitter, but other method steps can be preformed at either end.

Even though the invention is described above with reference to an example according to the accompanying drawings, it is clear that the invention is not restricted thereto but it can be modified in several ways within the scope of the appended claims.

1. A pre-distortion method in a communication system, the communication system comprising at least one transmitter and at least one receiver, the method comprising:
defining in-phase and quadrature differences of a received signal sample and a symbol decision for each constellation point, and conveying the defined in-phase and quadrature differences to a transmitter;
forming power intervals on the basis of a modulation method used;
determining a power of a signal to pre-distort, quantizing the power in a predetermined way and selecting a corresponding power interval;
averaging the in-phase and quadrature differences, rotating the averaged in-phase and quadrature differences towards an in-phase axis of an in-phase and quadrature plane and performing amplification and a running mean calculation for deriving parameters defining a linear curve segment of the selected corresponding power interval; and
calculating a gain factor by using the parameters defining the linear curve segment of the selected corresponding power interval for obtaining a pre-distorted signal.

2. A pre-distortion method in a communication system, the communication system comprising at least one transmitter and at least one receiver, the method comprising:
defining in-phase and quadrature differences of a received signal sample and a symbol decision for each constellation point, and conveying the defined in-phase and quadrature differences to a transmitter;
forming power intervals on the basis of a modulation method used;
determining a power of a signal to pre-distort, quantizing the power in a predetermined way and selecting a corresponding power interval;
deriving parameters defining a linear curve segment of the selected corresponding power interval; and
calculating a gain factor by using the parameters defining the linear curve segment of the selected corresponding power interval for obtaining a pre-distorted signal.

3. The method of claim 2, further comprising averaging the in-phase and quadrature differences directly at an in-phase and quadrature-level.

4. The method of claim 2, further comprising minimizing a number of measurements for defining the in-phase and quadrature differences of the received signal sample by rotating constellation points to a 1^{st} quadrant of a constellation diagram.

5. The method of claim 2, further comprising creating a gain factor for reference points that are between two constellation diagram circles by using interpolation.

6. The method of claim 2, further comprising creating a gain factor for reference points that are below an innermost circle or above an outermost circle of the constellation diagram by using extrapolation.

7. The method of claim 2, further comprising averaging distortion measurements relative to reference points that are on a same constellation circle.

8. The method of claim 2, wherein said forming comprises forming the power intervals on the basis of the modulation method used, wherein the modulation method used in the telecommunication system comprises multilevel-quadrature amplitude modulation.

9. The method of claim 1, further comprising performing an amplification and a running mean calculation as follows:
$${\underline{rm}}_{n} ( i ) = {\underline{rm}}_{n - 1} ( i ) + \frac{C \cdot {\underline{err}}_{{av\_circ}_{n}} ( i ) - {\underline{rm}}_{n - 1} ( i )}{N} .$$

10. The method of claim 1, further comprising performing an amplification and a running mean calculation as follows:
$${\underline{rm}}_{n} ( i ) = \frac{C}{N} \cdot {\underline{err}}_{{av\_circ}_{n}} ( i ) + ( 1 - \frac{1}{N} ) \cdot {\underline{rm}}_{n - 1} ( i ) .$$

11. The method of claim 2, further comprising:
deriving parameters defining the linear curve segment of the selected corresponding power interval by averaging the in-phase and quadrature differences, rotating the averaged in-phase and quadrature differences towards an in-phase axis of an in-phase and quadrature plane, and performing amplification and a running mean calculation.

12. A receiver of a communication system, the receiver comprising:
means for defining in-phase and quadrature differences of a received signal sample and a symbol decision for each constellation point; and
means for conveying the defined in-phase and quadrature differences to a transmitter.

13. The receiver of claim 12, further comprising means for minimizing a number of measurements for defining the in-phase and quadrature differences of the received signal sample by rotating constellation points to a 1^{st} quadrant of a constellation diagram.

14. The receiver of claim 12, wherein a modulation method used in the receiver comprises multilevel quadrature amplitude modulation.

15. A transmitter of a communication system, the transmitter comprising:
means for determining power of a signal to pre-distort, quantizing the power in a predetermined way and selecting a corresponding power interval;
means for averaging in-phase and quadrature differences, rotating the averaged in-phase and quadrature differences towards an in-phase axis of an in-phase and quadrature plane and performing amplification and a running mean calculation for deriving parameters defining a linear curve segment of the selected corresponding power interval;
means for calculating a gain factor by using the parameters defining the linear curve segment of the selected corresponding power interval; and
means for obtaining a pre-distorted signal.

16. A transmitter of a communication system, the transmitter comprising:
means for determining power of a signal to pre-distort, quantizing the power in a predetermined way and selecting a corresponding power interval;
means for deriving parameters defining a linear curve segment of the selected corresponding power interval;
means for calculating a gain factor by using the parameters defining the linear curve segment of the selected corresponding power interval; and
means for obtaining a pre-distorted signal.

17. The transmitter of claim 15, further comprising means for creating a gain factor for reference points that are between two constellation diagram circles by using interpolation.

18. The transmitter of claim 15, further comprising means for creating a gain factor for reference points that are below an innermost circle or above an outermost circle of a constellation diagram by using extrapolation.

19. The transmitter of claim 15, further comprising means for averaging reference points that are on a same constellation circle.

20. The transmitter of claim 15, wherein a modulation method used in the transmitter comprises multilevel quadrature amplitude modulation.

21. The transmitter of claim 15, further comprising means for performing an amplification and a running mean calculation as follows:
$${\underline{rm}}_{n} ( i ) = {\underline{rm}}_{n - 1} ( i ) + \frac{C \cdot {\underline{err}}_{{av\_circ}_{n}} ( i ) - {\underline{rm}}_{n - 1} ( i )}{N} .$$

22. The transmitter of claim 15, further comprising means for performing an amplification and a running mean calculation as follows:
$${\underline{rm}}_{n} ( i ) = \frac{C}{N} \cdot {\underline{err}}_{{av\_circ}_{n}} ( i ) + ( 1 - \frac{1}{N} ) \cdot {\underline{rm}}_{n - 1} ( i ) .$$

23. The transmitter of claim 16, further comprising
means for deriving parameters defining the linear curve segment of the selected corresponding power interval by averaging the in-phase and quadrature differences, rotating the averaged in-phase and quadrature differences towards an in-phase axis of an in-phase and quadrature plane and performing amplification and a running mean calculation.

24. A receiver of a communication system, the receiver comprising:
defining means defining in-phase and quadrature differences of a received signal sample and a symbol decision for each constellation point; and
conveying means conveying the defined in-phase and quadrature differences to a transmitter.

25. A transmitter of a communication system, the transmitter comprising:
power processing means determining power of a signal to pre-distort, quantizing the power in a predetermined way and selecting a corresponding power interval;
averaging means averaging in-phase and quadrature differences, rotating the averaged in-phase and quadrature differences towards an in-phase axis of an in-phase and quadrature plane and performing amplification and a running mean calculation for deriving parameters defining a linear curve segment of the selected corresponding power interval;
calculating means calculating a gain factor by using the parameters defining the linear curve segment of the selected corresponding power interval; and
obtaining means obtaining a pre-distorted signal.

26. A transmitter of a communication system, the transmitter comprising:
power processing means determining power of a signal to pre-distort, quantizing the power in a predetermined way and selecting a corresponding power interval;
determining means determining parameters defining a linear curve segment of the selected corresponding power interval;
calculating means calculating a gain factor by using the parameters defining the linear curve segment of the selected corresponding power interval; and
obtaining means obtaining a pre-distorted signal.

27. A pre-distorter measurement arrangement of a receiver, the arrangement comprising:
means for defining in-phase and quadrature differences of a received signal sample and a symbol decision for each constellation point; and
means for conveying the defined in-phase and quadrature differences to a transmitter.

28. A pre-distorter structure of a transmitter, the structure comprising:
power processing means determining power of a signal to pre-distort, quantizing the power in a predetermined way and selecting a corresponding power interval;
averaging means averaging in-phase and quadrature differences, rotating the averaged in-phase and quadrature differences towards an in-phase axis of an in-phase and quadrature plane and performing amplification and a running mean calculation for deriving parameters defining a linear curve segment of the selected corresponding power interval;
calculating means calculating a gain factor by using the parameters defining the linear curve segment of the selected corresponding power interval; and
obtaining means obtaining a pre-distorted signal.

29. A pre-distorter structure of a transmitter, the structure comprising:
power processing means determining power of a signal to pre-distort, quantizing the power in a predetermined way and selecting a corresponding power interval;
determining means determining parameters defining a linear curve segment of the selected corresponding power interval;
calculating means calculating a gain factor by using the parameters defining the linear curve segment of the selected corresponding power interval; and
obtaining means obtaining a pre-distorted signal.

30. A connecting device of a communication system, the device comprising:
power processing means determining power of a signal to pre-distort, quantizing the power in a predetermined way and selecting a corresponding power interval;
averaging means averaging in-phase and quadrature differences, rotating the averaged in-phase and quadrature differences towards an in-phase axis of an in-phase and quadrature plane and performing amplification and a running mean calculation for deriving parameters defining a linear curve segment of the selected corresponding power interval;
calculating means calculating a gain factor by using the parameters defining the linear curve segment of the selected corresponding power interval; and
obtaining means obtaining a pre-distorted signal.

31. A connecting device of a communication system, the device comprising:
power processing means determining power of a signal to pre-distort, quantizing the power in a predetermined way and selecting a corresponding power interval;
determining means determining parameters defining a linear curve segment of the selected corresponding power interval;
calculating means calculating a gain factor by using the parameters defining the linear curve segment of the selected corresponding power interval; and
obtaining means obtaining a pre-distorted signal.
